(19) United States
(12) Patent Application Publication
(10) Pub. No.: US 2003/0014301 A1
(43) Pub. Date: Jan. 16, 2003

(54) Internet-based customer information system and method

(76) Inventors: Bruce H. Yaffe, New York, NY (US); Robert L. Edwards, Staten Island, NY (US)

Correspondence Address: BAKER & BOTTS, 30 ROCKEFELLER PLAZA, NEW YORK, NY, 10112

(21) Appl. No.: 09/902,360

(22) Filed: Jul. 10, 2001

(51) Int. Cl. G06F 17/60

(52) U.S. Cl. 705/11

(57) ABSTRACT

A system and method to notify customers of the status of a service provider's timeliness in meeting appointments of scheduled customers throughout the course of a day, as the service provider services each customer is disclosed. In particular, the present invention provides for a customer to access the web site of a service provider, such as a doctor, through the Internet to verify whether or not the service provider is meeting his or her appointments with customers “on-time.”

### FIELD OF THE INVENTION

The present invention relates generally to customer information systems. In particular, the present invention relates to Internet-Based presentation of customer information data.

### BACKGROUND OF THE INVENTION

The Internet comprises a vast number of computers and computer networks that are interconnected through communication links. The interconnected computers exchange information using various services, such as electronic mail and the World Wide Web (“WWW”). The WWW allows a server computer system (i.e., a web server or web site) to send graphical text web pages of information to a remote client computer system. The remote client computer system can then display the web pages. Each resource (e.g., computer or web page) of the WWW is uniquely identifiable by a uniform resource locator (“URL”) corresponding to an internet protocol (IP) address. To view a specific web page, a client computer system specifies the URL for that web page in a request, typically a hyper text transfer protocol (“HTTP”) request. The request is forwarded to the web server that stores that web page. When that web server receives the request, it sends that web page to the client computer system. When the client computer system receives that web page, it typically displays the web page using a browser. A browser is a computer application that is a web page viewer.

The WWW has become a heavily-relied upon source for information for the public. However, most of the information contained on web pages is information which has been traditionally available in other mediums such as print publications, CD-ROMS, etc. Further, web pages often contain links to enable a remote client to stream video or audio files. Streaming is a process by which a remote client desiring to view or listen to a video or audio file need not wait for the entire file to be download to the remote client. Rather, as the remote client receives the data of the audio or video file, the remote client is able to view the video or audio file before the entire file has been downloaded, as long as the download bit rate equals or exceeds the remote client's viewing bit rate. Streaming, similar to material contained on web pages is analogous to traditional mediums such as videotapes, audio cassettes, CDs and DVDs. There exist limited instances where the WWW has been used to present information which has not been available in another analogous form, even if that analogous form is not as user friendly and transportable as when presented in the WWW.

From the inception of professionals and craftspeople scheduling meetings, consultations, and examinations with customers, there has been the need to determine whether or not these service providers are meeting their scheduled appointments on time. This information is of extreme importance to a customer scheduled to meet with such a service provider. If a customer arrives for an appointment with a service provider on time and the service provider is running behind schedule due to appointments with others, the customer must waste time in the service provider's waiting room until the service provider is available. The customer may have a better use for such wasted time. A customer may have also rushed over to get to the appointment at the designated time and in doing so may have endangered themselves by speeding, etc. This above described scenario in fields such as medicine, law, accounting, automobile repair, restaurants and health and beauty (manicures, facial, etc.) services to name a few is a common problem.

Until now, no one has provided an Internet-related system and method for a customer to receive real-time information relating to the timeliness of a service provider in order for the customer to determine whether or not the service provider is meeting their schedule appointments on time and, if not, the amount of delay, such that the customer need not waste time.

### SUMMARY OF THE INVENTION

The present invention relates to a system and method to notify customers of the status of a service provider's timeliness in meeting appointments of scheduled customers throughout the course of a day, as the service provider services each customer. In particular, the present invention provides for a customer to access the web site of a service provider, such as a doctor, through the Internet to verify whether or not the service provider is meeting his or her appointments with customers “on-time.” The system and method of the present invention provide an “on-time” web page for the customer to view such appointment status data as well as an “update” web page to allow the service provider to update their status in meeting appointments as such status changes throughout the course of the day. If the on-time web page indicates that the service provider is delayed, the customer may opt to delay their time of arrival at the service provider's facility for efficiency of time. Further, the present system and method reduce the number of telephone calls placed to the service provider from customers inquiring as to service provider's timeliness in meeting appointments at any given time in the day.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 is an illustration of an Internet-based system for notifying customers of the status of a service provider's timeliness in meeting appointments in accordance with an exemplary embodiment of the present invention;

FIG. 2 is an illustration of a top level web page which provides the customers with a link to an “on-time” web page, for displaying the status of a service provider's timeliness in meeting appointments, to customers via the Internet in accordance with an exemplary embodiment of the present invention;

FIG. 3 is an illustration an “on-time” web page for displaying the status of a service provider's timeliness in meeting appointments in accordance with an exemplary embodiment of the present invention; and

FIG. 4 is an illustration an “update” web page used by the service provider to update the status of a service provider's timeliness in meeting appointments to maintain current data on the service provider's “on-time” web page for the system of FIG. 1 in accordance with an exemplary embodiment of the present invention.

### DETAILED DESCRIPTION OF THE INVENTION

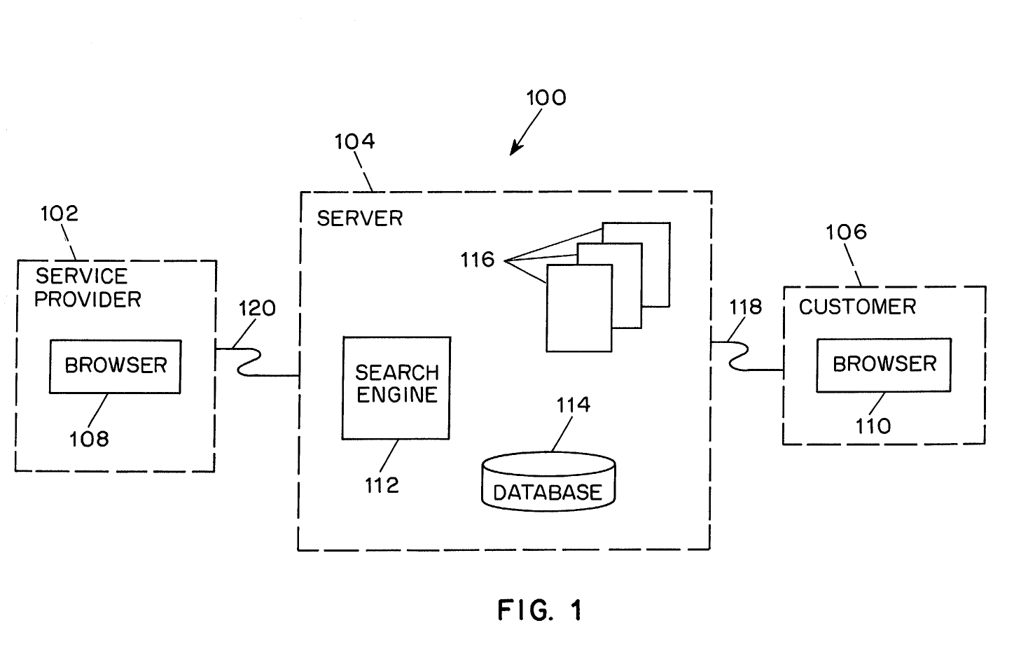

Now referring to the drawings, FIG. 1 illustrates an Internet-based appointment time status system for notifying customers of the status of a service provider's timeliness in meeting appointments in accordance with an exemplary embodiment of the present invention. Appointment time status system 100 includes a server 104, service provider device 102 and customer device 106. The server 104 includes a URL look-up table 112, database 114 and web pages 116. The service provider device 102 and customer device 106 each respectively contain web browsers 108, 110. The service provider device 102 communicates with the server 104 via connection 120. The customer device 106 communicates with the server 104 via connection 118. The customer device 106 may be any client device which is capable of displaying a web page, e.g. personal computer (PC), personal digital assistant (PDA), web appliance, etc. The service provider device 102 may be any client device which is capable of displaying a web page as well as inputting data., e.g. personal computer (PC), personal digital assistant (PDA), etc. Connections 118, 120 may be wireless or wired, where if wired connections 118, 120 may comprise a variety of materials capable of transmitting a signal, such as coaxial or optical cable. In addition, connections 118, 120 may be direct or indirect, e.g. passing through many routers and/or switchers between the source and destination of the signal propagating therein. In an exemplary embodiment, connections 118, 120 communicate with the server 104, service provider device 102 and customer device 120 using the transmission control protocol/Internet protocol (TCP/IP).

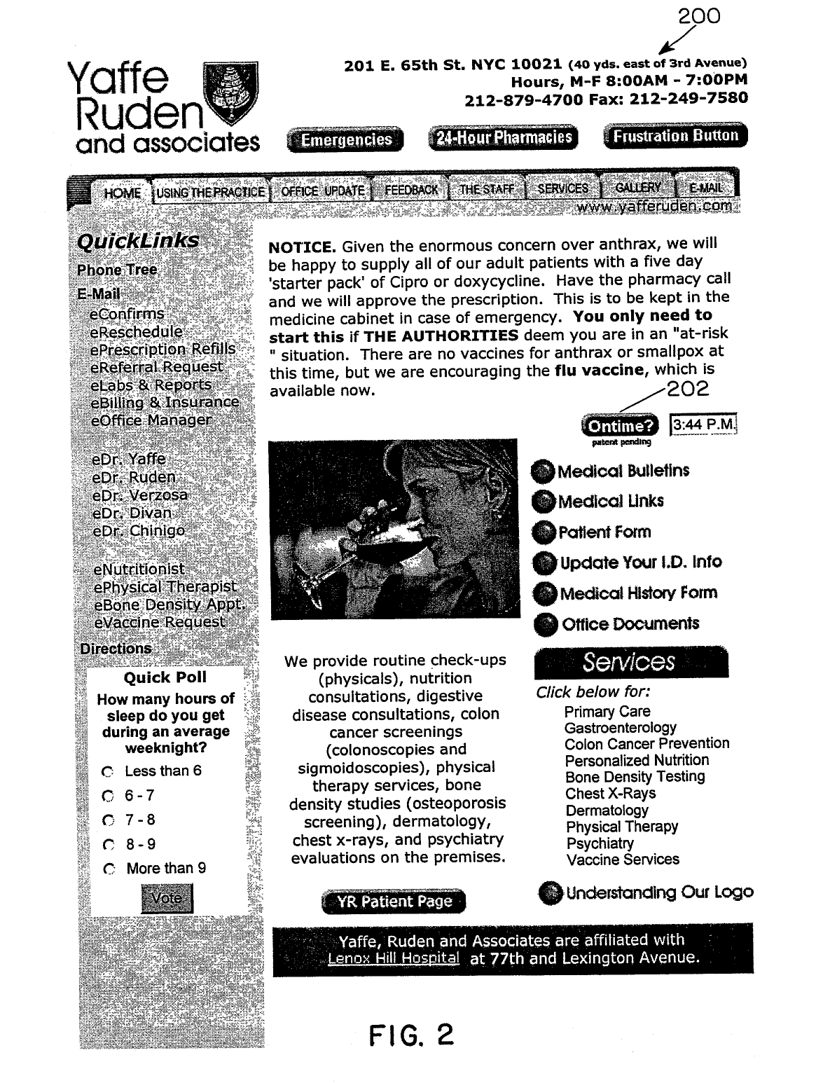

In operation, a customer wishing to know the service provider's timeliness first gains Internet access in accordance with well-known practices. Internet access may be accomplished by logging into an Internet service provider (ISP). The customer then invokes Internet browser 110 on the customer device 106. The customer browser 110 is a tool by which the customer may view web pages provided over the Internet. The customer then requests the customer browser 110 to display the top level web page 200, shown in FIG. 2, of the service provider by giving the customer browser 110 the URL for the top level web page 200. The customer device 104 sends the request to the server 104 via connection 118. The server 104 sends the request to its URL look-up table 112 to find the top level web page 200 amongst the many web pages 116 stored by the server 104. Once the URL look-up table 112 finds the top level web page 200, it sends the top level web page 200 to customer device 106 via connection 1118. Customer device 106 then displays the requested top level web page 200 on the customer browser 110.

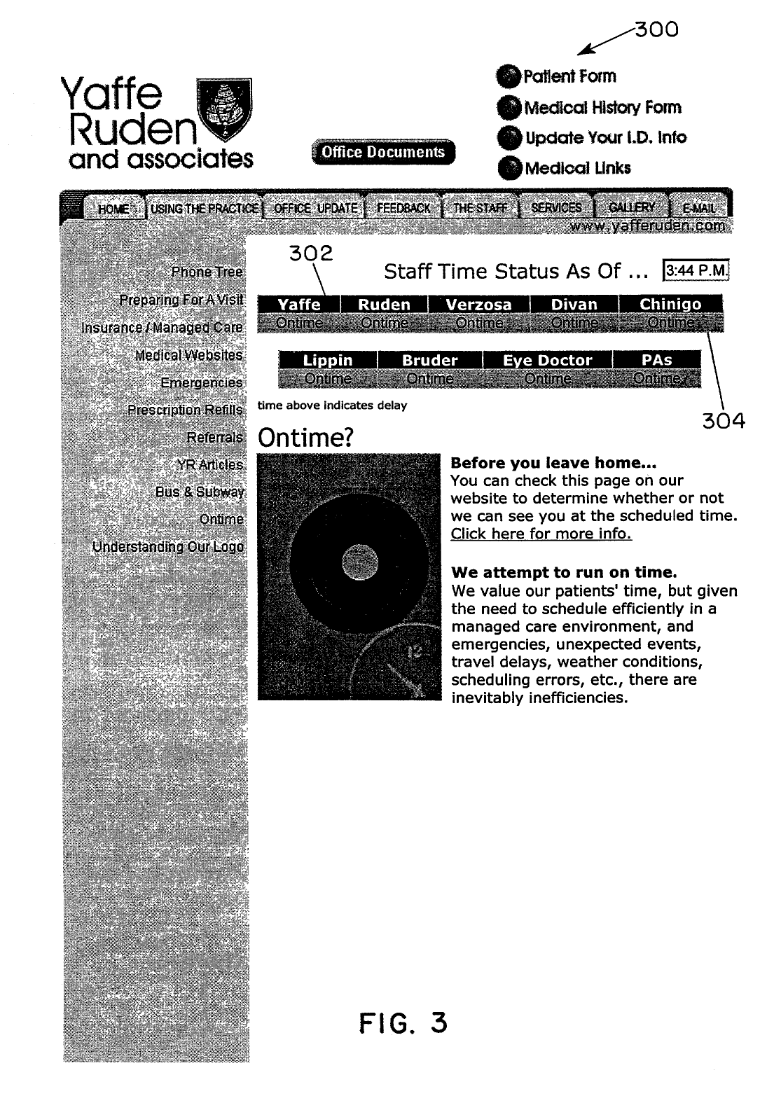

The customer, having received the top level web page 200 on the customer device 106, may access a link 202, by means of pointing and clicking for example, to an “on-time” web page 300. The “on-time” web page 300, shown in FIG. 3, is the web page which will show the customer the service provider's timeliness in meeting appointments. By accessing the link 202, the customer browser 110 requests the server 104 to send the customer browser 110 the on-time web page 300.

Similar to the above process, the server 104 sends the request for the “on-time” web page 300 to its URL look-up table 112 to find the requested “on-time” web page 200 amongst the many web pages 116 stored by the server 104. Once the URL look-up table 112 finds the “on-time” web page 300, it queries database 114 to acquire data to populate the time status fields 304. Once the data for the time status fields 304 is retrieved from database 114, server 104 sends the “on-time” web-page 300, with current time status fields 304 data, to customer device 106 via connection 118. Customer device 106 then displays the requested “on-time” web page 300 on the customer browser 110.

The “on-time” web page 300 includes name fields 302 for each individual with appointments at the service provider and a time status field 304 for each name field 302. The name field 302 is a static field and simply displays the name of each individual with appointments at the service provider. The time status field 304 is a dynamic field, modified as described below, and contains data indicating whether an individual with appointments at the service provider is meeting his or her appointments with customers “on-time.” If the individual is meeting his or her appointments, “on-time” is displayed in the time status field 304 associated with that individual's name field 302. If the individual is not meeting his or her appointments, the amount of time delay is displayed in the time status field 304 associated with that individual's name field 302, e.g. 5 minutes, 10 minutes, etc.

Alternatively, instead of going to the top level web page 200, the customer may access the on-time web page 300 directly by entering the URL for the “on-time” web page 300 in the customer browser 110.

The real-time time status information displayed in time status fields 304 is maintained in database 114 as described above and is updated to maintain its real-time status by the service provider. If all individuals at the service provider are meeting their appointments, then the real-time data is maintain by no activity on the part of the service provider, as “on-time” for the time status fields 304 is the default. If an individual is not meeting his or her appointment then, the service provider must update the database 114 with an accurate delay time amount.

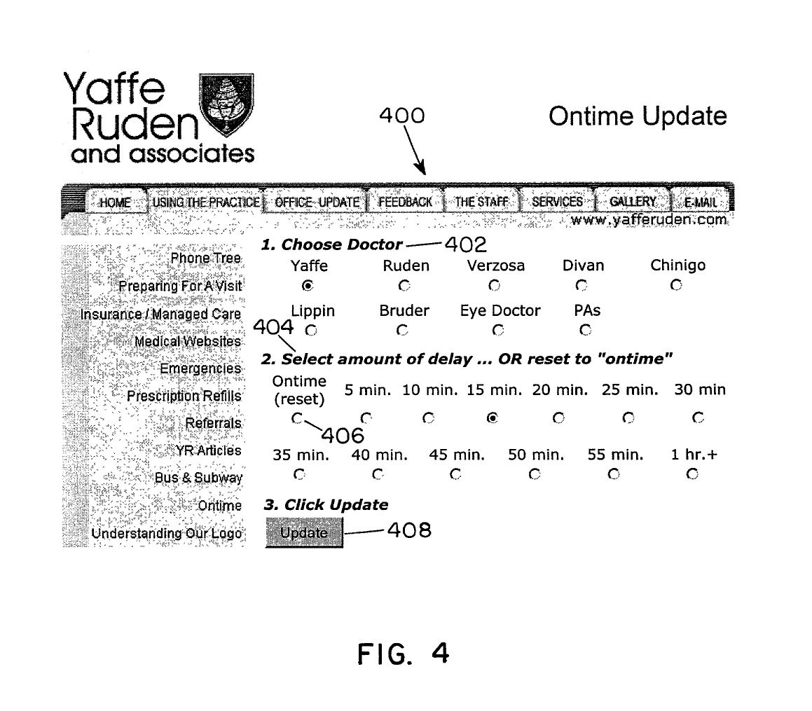

To update database 114, the service provider accesses the Internet. Again, Internet access may be accomplished, in accordance with known practices, by logging into an ISP. The service provider invokes the service provider browser 108 on the service provider device 102. The service provider browser 108 is a tool by which the service provide may update database 114 as well as view the “on-time” web page 300 provided over the Internet. The service provider requests service provider browser 108 to display an update web page 400, shown in FIG. 4. The service provider device 102 sends the request to the server 104 via connection 120. The server 104 sends the request to its URL look-up table 112 to find the requested update web page 400 amongst the many web pages 116 stored in server 104. Once the URL look-up table 112 finds the update web page 400, it then sends update web page 200 to service provider device 106 via connection 118. Service provider device 102 then displays the requested update web page 400 on the service provider browser 108.

Once the service provider receives the update web page 400, the service provider may first choose an individual to update time status data by selecting one of the person radio buttons 402, one for each individual. Next, the service provider selects the amount of delay by selecting one of the delay radio buttons 404, or if there is no delay the service provider selects the on-time radio button 406. In addition or alternatively, blank fields may be provided to be filled in with a service provider and/or amount of delay. Once the data has been entered, the service provider selects an update button 408. Upon selecting the update button 408, the selected updated data from update web page 400 is sent to database 114 via connection 120.

The database 114 receives this updated data and modifies the appropriate field(s) in the database with the updated data. In one embodiment, the server 104 then automatically sends the service provider device 102 the current “on-time” web page 300 which includes the updated data from the update web page 400 in the time status fields 304. In this way the service provider may verify that the data was updated properly.

The present system and method provides customers with the status of a service provider's timeliness in meeting appointments of scheduled customers throughout the course of a day, as the service provider attends to each customer, by using Internet web pages to display information reflecting a service provider's timeliness of appointments. If the “on-time” web page indicates that the service provider is delayed, the customer may opt to delay their time of arrival at the service provider's facility for efficiency of time. Further, the present system and method reduce the number of telephone calls placed to the service provider from customers inquiring as to service provider's timeliness in meeting appointments.

Although the present invention has been described in detail with reference to specific exemplary embodiments thereof, various modifications, alterations and adaptations may be made by those skilled in the art without departing from the spirit and scope of the invention. It is intended that the invention be limited only by the appended claims.

1. A system for notifying customers of the timeliness of a service provider in meeting appointments of scheduled customers, said system comprising:
a server for providing an on-time web page, said on-time web page containing information indicating timeliness of a service provider in meeting a schedule of appointments;
at least one customer device, said at least one customer device connected to said server by a first connection, said at least one customer device receiving said on-time web page from said server and displaying said on-time web page; and
a service provider device, said service provider device connected to said server by a second connection, said service provider device sending updated information to said server indicating changes in timeliness of a service provider in meeting a schedule of appointments.

2. The system of claim 1, wherein said server comprises a computer network server.

3. The system of claim 1, wherein said service provider device comprises a personal computer.

4. The system of claim 1, wherein said service provider device comprises a personal digital assistance with an input component.

5. The system of claim 1, wherein said customer device comprises a personal computer.

6. The system of claim 1, wherein said customer device comprises a personal digital assistant.

7. The system of claim 1, wherein said customer device comprises a web appliance.

8. The system of claim 1, wherein said first connection comprises optical cable.

9. The system of claim 1, wherein said first connection is wireless.

10. The system of claim 1, wherein said first connection comprises coaxial cable.

11. The system of claim 1, wherein said second connection comprises optical cable.

12. The system of claim 1, wherein said second connection is wireless.

13. The system of claim 1, wherein said second connection comprises coaxial cable.

14. The system of claim 1, wherein said customer device comprises a customer browser, said customer browser displaying said on-time web page.

15. The system of claim 1, wherein said service provider device comprises a service provider browser, said service provider browser displaying an update web page, said update web page comprising said updated information, said update web page being sent to said server such that said server receives said updated information and modifies said information indicating timeliness in response to receiving said updated information.

16. The system of claim 1, wherein said server comprises:
a database for storing said information indicating timeliness; and
a look-up table, said look-up table locating said on-time and update web pages amongst a plurality of web pages stored in said server.

17. A system for updating information indicating the timeliness of a service provider in meeting appointments of scheduled customers, said information being part of an on-time web page, said system comprising:
a service provider device, said service provider device connected to a server for providing said on-time web page to a customer device, said service provider device sending updated timeliness information to said server indicating changes in timeliness of a service provider in meeting a schedule of appointments, said service provider device comprising a service provider browser, said service provider browser displaying an update web page through which said updated timeliness information is entered, said update web page being sent to said server such that said server receives said updated timeliness information and modifies said information indicating timeliness in response to receiving said updated information.

18. The system of claim 17 further comprising said server.

19. A method for notifying customers of the timeliness of a service provider in meeting appointments of scheduled customers, said method comprising:
requesting an on-time web page from a server, said on-time web page comprising information indicating timeliness of a service provider in meeting a schedule of appointments;
accessing a database to retrieve said information indicating timeliness;
receiving said on-time web page with said information indicating timeliness; and
displaying said on-time web page on a web page browser.

20. The method of claim 19 further comprising updating said information indicating timeliness.

21. The method of claim 20, wherein said updating said information indicating timeliness comprises:
requesting an update web page, said update web page providing a selection to update said information indicating timeliness;
sending said update web page to said database; and
modifying said information indicating timeliness in said database in response to receiving updated information in said update web page.

22. The method of claim 21 further comprising receiving said on-time web page after said database modifies said information indicating timeliness in said database in response to receiving said updated information in said update web page.

23. A method for updating information on a database indicating the timeliness of a service provider in meeting appointments of scheduled customers, said method comprising:
requesting an update web page, said update web page providing a selection to update information indicating timeliness of a service provider in meeting appointments of scheduled customers;
entering updated information; and
sending said update web page to said database where said information indicating timeliness is modified.

24. The method of claim 23 further comprising receiving an on-time web page after said database modifies said information indicating timeliness in said database in response to receiving said updated information in said update web page.
